(19) United States
(12) Patent Application Publication
(10) Pub. No.: US 2020/0278596 A1
(43) Pub. Date: Sep. 3, 2020

(54) PROJECTOR DEVICE WITH THE CAPABILITY OF AVOIDING DEFOCUSING

(71) Applicant: AB Media & Marketing Inc., Richmond Hill (CA)

(72) Inventor: Bin Ren, Beijing (CN)

(21) Appl. No.: 16/592,204

(22) Filed: Oct. 3, 2019

(30) Foreign Application Priority Data
Mar. 1, 2019 (CN) 201910158883.1

(51) Int. Cl. G03B 21/14; G02B 7/02

(52) U.S. Cl. CPC G03B 21/147; G02B 7/02; G03B 21/145; G03B 21/142

(57) ABSTRACT

This invention concerns a projector which is able to prevent the device from defocusing, and it is under the category of projector technology. The invention includes light engine, lens, and mounting structure design. The lens is connected with the light engine by applying the mounting structure. The mounting design strengths the connection between the lens and the light engine to ensure the stabilization of the projector even in case of vibration; the relative position between the lens and the instrument will remain the same. In another word, the defocusing is avoided from the beginning to guarantee the high definition image.

### TECHNICAL FIELD

This invention concerns a projector which is able to prevent the device from defocusing, and it is under the category of projector technology.

### BACKGROUND

A projector includes light engine and lens, and the lens is mounted on the light engine. When the projector is being used, clear images would be presented if proper focus is adjusted. However, the focus could change while an external force is applied on the projector to cause vibration. Blur images would be presented due to the inappropriate focus. The lens of a projector is a highly precise structure, and the mounting of the lens upon the light engine is not locked. During vibration, the relative position between the lens and the light engine changes to cause defocusing.

### SUMMARY

This invention provides a projector device with capability of avoiding defocusing, and it is used to solve the technical problem of blur image caused by defocusing.

The solution of the technical problem is listed below: a projector device with capability of avoiding defocusing includes light engine, lens, and mounting structure design. The lens is connected with the light engine by applying the mounting structure.

Moreover, to achieve the goal, the light engine has the first thread hole; the lens has the second thread hole.

Mounting structure includes the first mounting board and the first screw, and the first mounting board has one the first hole and connection thread hole. The first screw gets through the first via hole to install the first mounting board to the light engine by the first thread hole.

The mounting structure also includes the second mounting board, the second screw, and compression screw. The second mounting board is designed with the second hole and the third hole. The second screw gets through the second hole and fits into the second thread hole. The compression screw gets through the third via hole and fits in its thread hole.

Furthermore, to achieve the goal, the mounting structure has a compression board and the third screw. The second mounting board is designed with the third thread hole, and the compression board has the fourth hole. The compression board compresses the nut of the compression screw and gets through the fourth hole to fit in the third thread hole.

Moreover, to achieve the goal, the third hole is a waist-type hole, and its length direction is the same as the axis of the lens.

Furthermore, to achieve the goal, there are two first holes. The top face of the first mounting board is designed with Column A, and Column A is located between two first holes. The connection thread hole is at the top face of Column A. There are three first thread holes along the axis of the lens. The first thread hole is at the left and one of the threads holes at the right are designed for two first holes.

Moreover, to achieve the goal, the contacting surface of first mounting board which is next to the light engine is curvy.

Furthermore, to achieve the goal, the area where the second mounting board faces to Column A is convex. The third hole is designed on the top face of the convex, and Column A is inserted into the convex.

Moreover, to achieve the goal, the second mounting board also has another two Column B, and the convex is located between two Column B. The second hole is located at one side of two Column B, and the top face of each Column B has a third thread hole.

Furthermore, to achieve the goal, the surface of which is next to the light engine is curvy as well.

Moreover, to achieve the goal, the compression screw is a truss head screw.

This invention has following advantages compared with the current technology:

This invention, the projector device with capability of avoiding defocusing, includes light engine, lens, and mounting structure design. The lens is connected with the light engine by applying the mounting structure. The mounting design strengths the connection between the lens and the light engine to ensure the stabilization of the projector even in case of vibration; the relative position between the lens and the instrument will remain the same. In another word, the defocusing is avoided from the beginning to guarantee the clear image.

### BRIEF DESCRIPTION OF THE DRAWINGS

To better explain the technical solutions in application examples or current technology, here are the description of the attached drawings which are used in application examples or current technology. Obviously, the following attached drawings are just the application examples of this invention. To the general technical people in this industry, other attached drawings could be obtained according to the following attached drawings without any creative effort.

FIG. 1 is the assembly drawing of the projector device with capability of avoiding defocusing.

FIG. 2 is the exploded drawing of FIG. 1.

FIG. 3 is the first mounting board of this invention.

FIG. 4 is the second mounting board of this invention.

FIG. 5 is another view of FIG. 4.

FIG. 6 is compression board of this invention.

FIG. 7 is another view of FIG. 6.

In the Drawing:
1—light engine; 11—the first thread hole
2—lens; 21—the second thread hole
3—the first mounting board; 31—the first via hole; 32—connection thread hole; 33—Column A
4—the first screw
5—the second mounting board; 51—the second via hole; 52—the third via hole; 53—the third thread hole; 54—convex; 55—Column B; 56—mounting holes
6—the second screw
7—Compression screw
8—Compression board; 81—the fourth via hole; 82—mounting column; 83—window
9—the third screw

### DETAILED DESCRIPTION

More details of the technology will be described by application examples in the following section to better demonstrate the objectives, solutions and advantages of the technology. However, the examples listed in this patient only cover part of applications instead of all capable solutions. Based on the applications listed in this patent, all other similar solutions will be protected by this patent, unless an innovative method is proposed by other technicians in this field.

Application 1:

This example gives a solution of an anti-blurry projector device. It consists of a light engine (1) and a lens (2). The lens (2) is installed onto the light engine (1), and they form a conventional structure that are used in normal projectors. The device also has a locker which is installed between the light engine (1) and the lens (2) and it connects them on each side. The addition of the locking mechanism between the two main components helps to fix the components and increase the stability of the whole structure. It tightly connects the lens (2) and the light engine as a combined unit and their relative position will not change under vibrations. By this method, the focus shift of the projection can be avoided from the source, and as the result, it can prevent the blurry projected images.

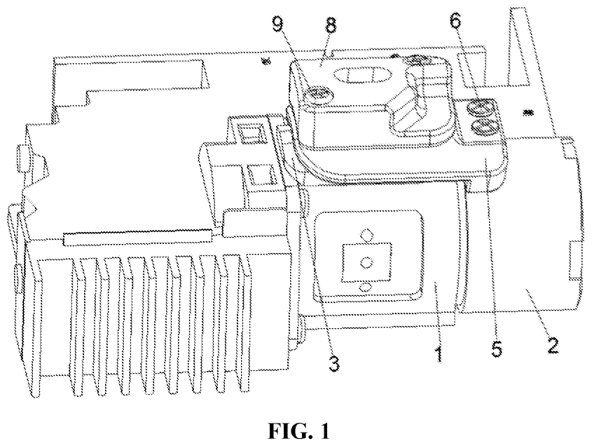

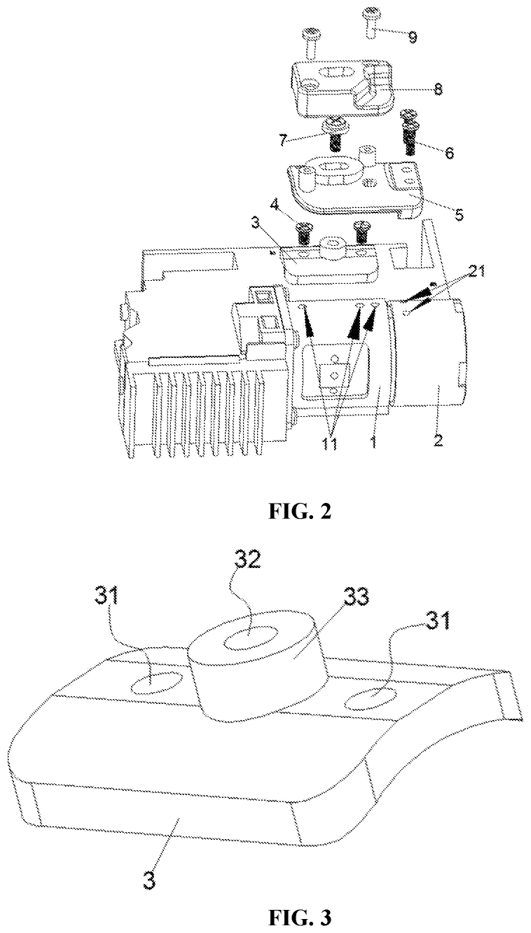

The detailed structure of the device is illustrated in FIG. 1 to FIG. 6. The light engine (1) in this example has the first thread hole (11) and the lens (2) has a second thread hole (21). The locking structure introduced above includes the first mounting board (3) and the first screw (4). The first mounting board (3) has a first through hole (32) and a connection thread hole (32). The first screw (4) passes through the first via hole (31) and it is screwed to the first thread hole (32). So, the first mounting board (3) is connected to the light engine (1) and it is removable.

This locking structure also includes the second mounting board (5), the second-screw (6) and compression (7). The second mounting board (5) has the second via hole (51) and the third via hole (52). The second screw (6) passes through the second via hole (51) and it is screwed to the second thread hole (21). That holds together the second mounting board and the lens (2). Similarly, the compression screw (7) passes through the third via hole (52) and it is screwed to the connection threaded hole (32). That holds together the second mounting board (5) and the first mounting board (3). Since the first mounting board (3) connects with the light engine (1) through the first screw (4), by applying that structure, the lens (2) and the light engine (1) is connected together as a stable unit. The first mounting board (3) and the second mounting board (5) in this example are made of rigid plastic material that is not elastic. Therefore, the relative position between the lens (2) and the light engine (1) can be tightly locked by the first mounting board (3), the second mounting board (5), the first screw (4), the second screw (6) and the compression screw (7).

When the second mounting board (5) is connected with the first board, the second board (5) presses the first screw (4) to fix and tighten it. Therefore, the first order self-lock is achieved.

The locker also includes compression board (8) and a third screw (9). The second mounting board (5) has a third thread hole (53). The compression board (8) has a fourth through hole (81). The third screw (9) goes through the hole (8), and it is screwed into the threaded hole (53). Then the nut of the compression screw (7) is tightly pressed by the compression board (8), which makes the compression screw (7) immovable. So, the second order self-lock is achieved. By adopting that structure, the compression force of the compression board (8) can avoid the loose of the compression screw (7), and similarly, the second mounting board (8) can prevent the loose of the first-screw (4). Therefore, the whole locking mechanism firmly connects the lens (1) and the light source (1), and it make the projector more resistance to the vibrations.

Application 2:

The method demonstrated in this example is a better solution comparing with the example 1. The third via hole (52) used in this example is a slotted hole, and its long side is parallel with the axis of the lens (2). This setup has two first via holes (31) that are located on the left and the right along the axis of the lens (2). It also has three first thread holes (11) that are also aligned along the axis of the lens (2). The one first thread hole (11) and one of the other two first thread holes (11) are one-to-one correspondence to the two first via holes (31).

By applying this structure, the compression screw (7) can move left and right inside the third via hole (52). The user can align one of the two first-threaded hole (11) with the first via hole (31) which is on right side of first mounting board (3). When the user performs the focus adjustment, the lens (2) can be easily adjust along is axis and it can be locked up at the proper position.

In addition, the first mounting board (3) has a Column A (33) between the two first via holes (31). The connecting threaded hole (32) is drilled on the top surface of the Column A (33), which extends the connecting depth of the threaded hole (32). That allows the compression screw (7) to have a longer connecting length with the connection threaded hole (32), and thus it builds up a stronger connection between the second mounting board and the first mounting board.

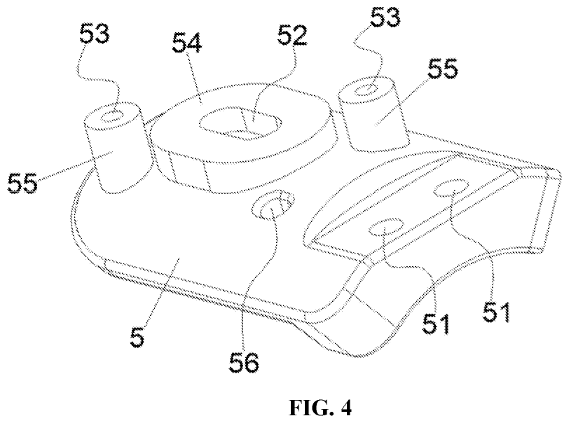

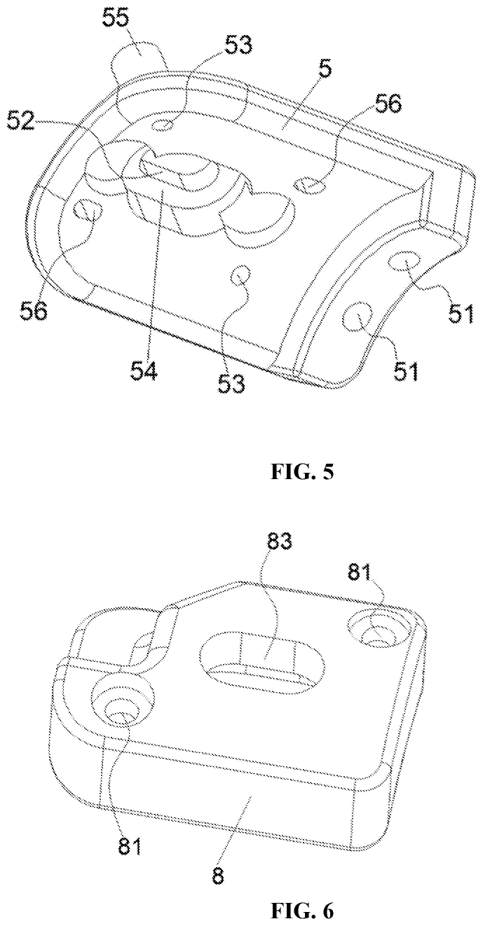

As shown in FIG. 3, FIG. 4, and FIG. 5, the fitting surface between the first mounting board (3) and the light engine (1) is curved. And the fitting surface between the second board (5) and the lens (2) is also curved. The curved fitting surface could create a better fit on the surface between the components that can further enhance the connection stability.

Application 3:

In this example, as illustrated in FIG. 3, the area on the second mounting board (5) that is right against the Column A (33) has a convex shape structure to form a bump shell (54). And the Column A (33) is inserted into the bump shell (54), which makes the structure more compact. The third via hole (52) is opened on the top of the bump shell (54). When they are assembled, the bump shell (54) will cover the Column A (33).

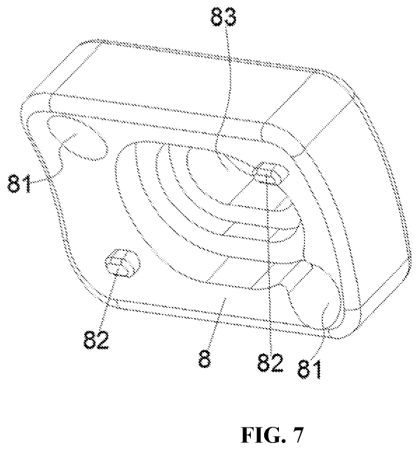

As displayed in FIG. 4, the second mounting board (5) has two Column B (55) towards upward on this top surface. The bump shell (54) is located between the two Column B (55). Each Column B has a third thread hole (53) on its top. The second via hole (52) is on the same side with the two Column B (55) and, as a result, it makes the third thread hole to become deeper. As shown in FIGS. 6 and 7, the compression board (8) has two fourth via holes, which is correspondence to the two third-threaded holes (53). That can further enhance the connection stability.

As illustrated in FIG. 7, there is a positioning pole (82) on the bottom side of the compression board (8) and the second mounting board (5) has a positioning hole (56). When the compression board is pressed onto the second mounting board (5), the position pole (82) inserts into the positioning hole (56). The positioning pole and hole restrict their relative movements, which makes the connection more stable.

In addition, there is notch on the bottom side of the compression board (8) which is aligned with the bump shell (54). The notch has a window (83) on the bottom, which makes it convenient for inspecting the position of the compression screw (7). And the edge of the window (83) press the nut of the compression screw (7).

Truss head screw is used for the compression screw (7), which is the best manner in this solution.

The examples demonstrated above only cover some specific applications of this technology. However, the scope of protection of the similar technologies that are under protected by this patient is not limited to those examples. All other forms of solutions within that scope are also protected by this patent. Therefore, the scope of protection shall be subject to the claimed protection scope.

What is claimed is:

1. A projector device with capability of avoiding defocusing comprising:
a light engine connected to a mounting structure and a lens;
the lens connected with the light engine by applying a mounting structure; and
the mounting structure including a first mounting board and a second mounting board and a compression board for stabilizing the projector device, connected between the lens and the light engine.

2. The projector device of claim 1, wherein the light engine includes a plurality of holes on the light engine along the direction of the lens, including one of them at left and another one at right designed for two first via holes.

3. The projector device of claim 1, wherein the first mounting board includes two first via holes for being mounted on the light engine by two first screws passing through and mounting with two first thread holes respectively.

4. The projector device of claim 1, wherein the first mounting board further includes a connection thread hole at the surface of a column A along the direction of the lens for being mounted by a compression crew getting through and mounting with a third via hole to connect the first mounting board and the second mounting board.

5. The projector device of claim 2, wherein the column A is inserted into a convex side of the second mounting board.

6. The projector device of claim 1, wherein the second mounting board includes two second via holes located at one side of two columns B for being mounted on the lens by two second screws getting through respectively.

7. The projector device of claim 1, wherein the second mounting board further includes the third via hole on the top face of a convex for being mounted by the compression crew getting through.

8. The projector device of claim 7, wherein the third via hole is a waist-type hole.

9. The projector device of claim 8, wherein the third via hole is located at the same direction as the axis of the lens.

10. The projector device of claim 1, wherein the second mounting board further includes two third holes on the two columns B located two sides of the convex respectively.

11. The projector device of claim 1, wherein the second mounting board next to the light engine is curvy.

12. The projector device of claim 1, wherein the compression board includes two fourth via holes for being mounted on the second mounting board by two third screws getting through respectively.

13. The projector device of claim 1, wherein the compression board further includes two mounting columns on the bottom side inserted into the positioning hole of the second mounting board for positioning.

14. The projector device of claim 1, wherein the compression screw is a truss head screw and passes through the third via hole and screwed to the connection thread hole for holding the second mounting board and the first mounting board together.
